(19) United States
(12) Patent Application Publication
(10) Pub. No.: US 2007/0261383 A1
(43) Pub. Date: Nov. 15, 2007

(54) Method and Device For Influencing Combustion Processes, In Particular During the Operation of a Gas Turbine

(75) Inventors: Werner Hartmann, Weisendorf (DE); Jorg Kieser, Forchheim (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT, München (DE)

(21) Appl. No.: 11/663,779

(22) PCT Filed: Sep. 22, 2005
(86) PCT No.: PCT/EP05/54738

§ 371 Date: Mar. 26, 2007

(30) Foreign Application Priority Data
Sep. 27, 2004 (DE) 10 2004 046 814.1

(51) Int. Cl. F02C 3/00

(52) U.S. Cl. 60/39.01

(57) ABSTRACT

An embodiment of the invention relates to the use of electromagnetic fields for influencing combustion processes. According to an embodiment of the invention, the flame is controlled by the coupling of repeated, inductive, pulsed energy. The associated device uses at least one induction coil that at least partially surrounds the flame and the device is equipped with a controllable switch or a high frequency generator.

The invention relates to a method for influencing combustion processes, in particular during the operation of a gas turbine, wherein pilot flames are used for maintaining combustion over a wide parameter range, the flame control of which is carried out via electromagnetic fields. In addition, the invention relates to a device for implementation of the method.

The pilot flames which are required for maintaining combustion over a wide parameter range in gas turbines produce a not insignificant portion of pollutants, especially nitrogen oxides (NOx). The pilot flames of a gas turbine have a narrow operating range and on account of the large inertia of a gas flow related control system, inter alia, are suitable only to a limited extent for control of the combustion process in the combustion chamber.

A widening of the working range of the pilot flames with simultaneous reduction of the production of pollutants, and also a very quick influenceability of the combustion process can very advantageously affect efficiency and pollutant emission.

In addition to the only limitedly possible and comparatively sluggish control of gas flow and combustion gas composition, methods to achieve a flame control via electrical fields were investigated for some time. This method leads to a widening of the operating range of the pilot flame with regard to the air ratio and also to a reduction of NOx content in the flue gas of the flame. Furthermore, a quick influencing of the flame is possible. The basic principle of an inductive coupling of electrical energy in a gas flow is known from DE 199 47 258 A1.

Furthermore, EP 1 215 392 discloses a device for energy coupling in a combustion chamber of a combustion engine, which chamber is charged with air-fuel, in order to ignite the air-fuel mixture.

Starting from the last prior art, it is the object of the invention to disclose an improved method for control of the combustion process and to create an associated device.

The object is achieved according to the invention by means of the measures of patent claim 1. An associated device is the subject of patent claim 6. Developments of the method and of the associated device are disclosed in the dependent claims.

According to the invention, an inductive, pulsed energy coupling is carried out via an induction coil which encompasses the flame, with the flame as the secondary winding of a pulse transformer. Such arrangements are known for the production of pinch processes, for example. In this case, the effect is preferably introduced in the outer region of the flame on account of the screening effect of the conductive flame plasma, so that these cold flame regions preferably receive an additional heating by means of the inductively effected, pulsed energy feed. In this way, the temperature pattern in the flame can be instantaneously homogenized across the cross section.

Since a very quick control of the combustion processes is carried out via the feed of electrical energy which is fed in a pulse-form manner, acoustic natural oscillations in, the combustion chamber region can also be compensated by means of corresponding back-fed control algorithms.

For the feed of electrical energy in the form of inductively transmitted power, two possibilities are available in principle:
energy feed in a series of individual pulses of short duration from microseconds (μs) to milliseconds (ms);
continuous (or quasi-continuous) feed of inductively coupled high-frequency power via at least one HF power generator.

A quickly controllable energy coupling in flames is achieved by the invention, by means of which an almost inertia-free control of the combustion process in the pilot flame is enabled right up to high thermal power levels in the MW range and above.

The advantages of the method according to the invention in both cases lie in the very quick controllability of the electrical power in the sub-milliseconds range when using correspondingly short power pulses, and also in the scalability to high gas pressures and in the coupling of high electrical power levels. In this way, very quick control processes, for example for the suppression of acoustic inherent modes in the combustion chamber, can also be realized.

The homogenization of the flame temperature leads to a reduction of the production of pollutants such as nitrogen oxides.

Furthermore, it is possible by the invention to also control the combustion process in the combustion chamber itself in a non-contacting manner; this can be carried out via a single, large induction system, or via a plurality of separate, spatially distributed, smaller induction systems, so that even a concerted, spatially resolved influencing of the combustion process is enabled. As a result, temperature spikes can be purposefully diminished, and consequently the NOx emission can be reduced, the combustion process (efficiency) optimized, and also acoustic resonances prevented. Flat coils are an especially favorable solution in this case.

Further details and advantages of the invention are apparent from the subsequent figure description of exemplary embodiments with reference to the drawing in conjunction with the further patent claims. In the drawing, in schematic view in each case:

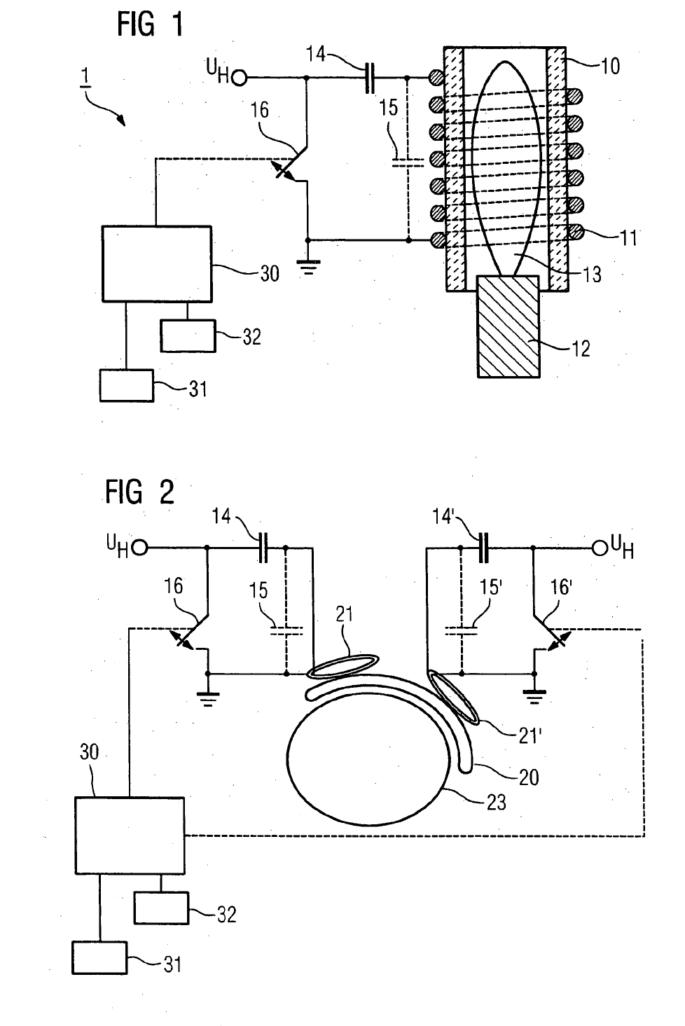

FIG. 1 shows the control of a turbine pilot flame by means of a pulse induction coil, which encompasses the flame, for coupling pulse energy,

FIG. 2 shows the control of the main flame in the combustion chamber of a gas turbine by means of distributed induction coils for the spatially controllable coupling of high-frequency energy,

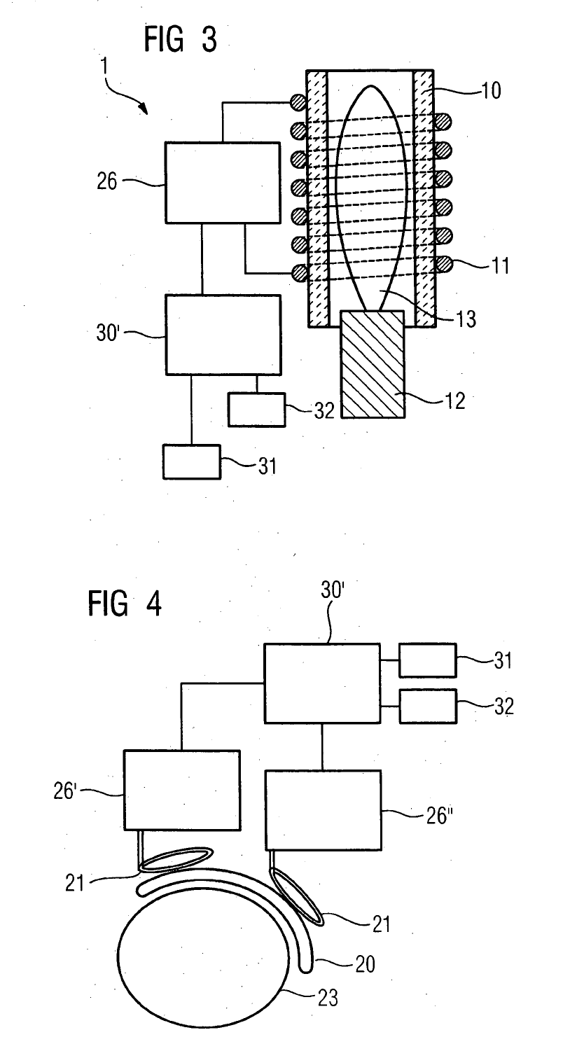

FIG. 3 shows a construction according to FIG. 1 with one HF generator and

FIG. 4 shows a construction according to FIG. 2 with two HF generators.

While in the CW range, the coupling of a power which is adequate for flame control is carried out over many oscillation periods in an averaged manner, in pulsed mode the energy which is coupled in the individual pulse must be adequate for it. In general, this is given in a very limited manner since the conductivity, and, therefore, the electrical impedance of the plasma of a flame, is comparatively low in comparison to the impedance of the necessary power pulse electronics.

Therefore, it is necessary to carry out an impedance adjustment of the power electronics to the impedance of the flame plasma. According to the invention, this is carried out by an electric current i being built up over a longer interval of time by means of a predominantly cylindrical coil, which encompasses the flame, through a normally-open switch (FIG. 1). In the region of the current maximum, the switch (or a second switch element which is connected in series to it) is opened, with a short time constant in comparison to the current build-up time. As a result of this, the magnetic energy E_{ind}=0.5*L*I² (G1.1), which is inductively stored in the coil inductance L, is transferred into the stray capacitance CS of the system in the form of a very high-frequency, high-voltage pulse; the electrical system comprises a coil inductance L as the primary side of an air-core transformer, and the associated low stray capacitance CS and also the plasma as the secondary side (single-winding) of an air-core transformer, and in this way represents a high-impedance arrangement. By this measure, a significantly improved impedance adjustment of the load to the energy source, and therefore a better power coupling in the flame plasma, is achieved than via a direct inductive coupling of the single pulse.

The interaction of the induced electrical field with the charge carriers in the flame plasma is enormously increased by this measure. A concerted charge carrier augmentation via impact ionization becomes possible by externally adjustable time constants of the switch, wherein according to the prior art (cf. pulsed electrostatic dust filter) it is quite possible to avoid a direct gas flashover.

Pulse repetition frequency and pulse amplitude are controlled via a control system which, via corresponding sensory devices (temperature; acoustic oscillations; exhaust gas composition; etc.), characterizes the instantaneous operating state of the gas turbine and controls it via a concerted additional energy feed to the pilot flame or even to the main flame.

It is proposed to apply this type of pulsed energy coupling for control of the pilot flames and the premix flames of gas turbines. Variants of the construction, which generate a higher pole field, are simple to realize and via corresponding selection of the phase positioning allow, for example, the induction of a rotational movement of the plasma. In this case, flat coils for local flame influencing can be advantageous, depending upon the type of application.

In FIG. 1, a device for flame control is identified by 1. In detail, 10 stands for a ceramic tube, upon which an induction coil 11 with inductance L is located. A burner is identified by 12, and the associated pilot flame is identified by 13.

There are suitable means for control of the induction coil: in this case, 14 and 15 represent condensers in each case, wherein the condenser 14 realizes a stray capacitance CS, and the condenser 15 realizes a pulse capacitance C_{P}. The condensers are connected to a high-voltage source U_{H}, and on the other side are connected to earth. There is a switch 16 which can be realized as a normally-closed switch or as a normally-open switch. The switch 16 is controlled by a control/regulating unit 30. Sensors 31, 32 serve as inputs for the control/regulating unit.

Pulse energy for control of the turbine pilot flame can be coupled with the arrangement according to FIG. 1.

The latter principle is transferred to the arrangement according to FIG. 2. In this case, 20 stands for a ceramic combustion chamber wall and 23 stands for the main flame in the turbine. Induction coils, which in FIG. 2 are formed as flat coils, are identified by 21 and 21′.

There can be a plurality of flat coils. Each of the flat coils has a control unit which in principle corresponds to the control unit corresponding to FIG. 1. In detail, this means that again there are condensers 14, 15 which realize a stray capacitance CS and a pulse capacitance C_{P}. The circuit is connected to a high-voltage source U_{H}, and there are switches 16, 16′ which are connected to corresponding sensors 31, 32 by a control/regulating unit 30. The individual control units can be intercoupled.

A spatially controllable coupling of high-frequency energy directly in the plasma of the main flame is possible by the distributed induction coils according to FIG. 2. The individual induction coils 21, 22 are advantageously constructed as flat coils. In FIG. 2, they are located outside the ceramic combustion chamber wall. In the case of an electrically conductive combustion chamber wall, they can also be located inside the combustion chamber.

In both cases of FIG. 1 and FIG. 2, quick controllability especially ensues, by which homogeneity of the flame temperature can be achieved. This brings about a reduction of the production of pollutants. The described devices enable the scalability to high gas pressures and to the coupling of high electrical power levels. Especially in this way, acoustic natural modes in the combustion chamber can also be suppressed.

By way of variation to FIGS. 1/2, in FIGS. 3 and 4 the controllable switch 16 or 16′, as the case may be, is replaced by one or two power HF generators 26 or 26′, as the case may be. Especially the frequency of the coupled power can be established by the HF generators. Apart from that, the arrangement of the induction coils and the control/regulating unit with the associated sensors is constructed according to FIGS. 1 and 2.

1. A device for maintaining combustion over a wide parameter range of pilot flames, with flame control being carried out via electromagnetic fields, the device comprising:
at least one induction coil, at least partially encompassing the flame; and
at least one controllable switch, associated with the least one induction coil so that the flame control is carried out via a repeated, inductive, pulsed energy coupling.

2. The device as claimed in claim 1, wherein the at least one induction coil is a cylindrical coil.

3. The device as claimed in claim 1, wherein the at least one induction coil includes a plurality of cylindrical coils.

4. The device as claimed in claim 1, wherein the at least one controllable switch is a normally-open switch.

5. The device as claimed in claim 1, wherein the at least one controllable switch is a normally-closed switch in communication with an energy accumulator in the form of a condenser.

6. The device as claimed in claim 1, wherein the at least one controllable switch includes two switch elements connected in series as a switching unit, the two switch elements including a normally-open switch and a normally-closed switch.

7. The device as claimed in claim 6, wherein pulse durations from microseconds to milliseconds are realized in the switching unit.

8. The device as claimed in claim 6, wherein at least one HF generator is connected to the induction coil.

9. The device as claimed in claim 1, further comprising at least one control/regulating unit, controlable by sensors.

10. The device as claimed in claim 9, wherein the at least one control/regulating unit includes a feedback loop by which acoustic oscillations are counter-controllable.

11. The device as claimed in claim 10, wherein the control/regulating unit includes a feedback loop by which the concentrations of pollutants in the exhaust gas are reducible.

12. The device as claimed in claim 11, wherein the control/regulating unit includes a feedback loop by which the thermodynamic efficiency of the combustion process in the flame is improveable.

13-18. (canceled)

19. The device of claim 1, wherein the device is for for influencing combustion processes for operation of a gas turbine.

20. The device as claimed in claim 2, wherein the at least one controllable switch includes two switch elements connected in series as a switching unit, the two switch elements including a normally-open switch and a normally-closed switch.

21. The device as claimed in claim 20, wherein pulse durations from microseconds to milliseconds are realized in the switching unit.

22. The device as claimed in claim 3, wherein the at least one controllable switch includes two switch elements connected in series as a switching unit, the two switch elements including a normally-open switch and a normally-closed switch.

23. The device as claimed in claim 22, wherein pulse durations from microseconds to milliseconds are realized in the switching unit.
